(19) United States
(12) Patent Application Publication
(10) Pub. No.: US 2016/0290645 A1
(43) Pub. Date: Oct. 6, 2016

(54) AXISYMMETRIC OFFSET OF THREE-DIMENSIONAL CONTOURED ENDWALLS

(71) Applicant: UNITED TECHNOLOGIES CORPORATION, Farmington, CT (US)

(72) Inventor: Jesse M. Carr, Hartford, CT (US)

(21) Appl. No.: 15/037,914

(22) PCT Filed: Nov. 10, 2014
(86) PCT No.: PCT/US2014/064762

§ 371 Date: May 19, 2016

Related U.S. Application Data
(60) Provisional application No. 61/907,092, filed on Nov. 21, 2013.

(51) Int. Cl. F23R 3/00; F01D 17/10; F01D 25/30; F04D 29/52; F01D 9/02; F01D 25/24

(52) U.S. Cl. CPC F23R 3/002; F01D 9/023; F01D 25/24; F01D 25/30; F04D 29/522; F01D 17/105; F05D 2220/32; F05D 2250/73

(57) ABSTRACT

An engine component includes a gaspath wall defining a radially outward facing gaspath surface and an opposed non-gaspath surface. The gaspath surface defines a non-axisymmetric contour with a respective point of minimum radius for each axial position. The non-gaspath surface defines an axisymmetric contour. Each axial position on the axisymmetric contour defines a circle offset from the respective point of minimum radius of the gaspath surface by a predetermined minimum wall thickness. The predetermined minimum wall thickness is substantially constant as a function of axial position. A similar predetermined minimum wall thickness and axisymmetric non-gaspath surface contour can be applied to a gaspath wall with a radially inward facing gaspath surface defining a non-axisymmetric contour.

### RELATED APPLICATIONS

This application claims the benefit of and priority to U.S. Provisional Patent Application No. 61/907,092 filed Nov. 21, 2013, the contents of which are incorporated herein by reference in their entirety

### STATEMENT REGARDING FEDERALLY SPONSORED RESEARCH OR DEVELOPMENT

This invention was made with government support under contract number FA8650-09-D-2923-0021 awarded by the United States Air Force. The government has certain rights in the invention.

### BACKGROUND OF THE INVENTION

1. Field of the Invention

The present disclosure relates to engine components, and more particularly to gaspath walls with non-axisymmetric surface contours, such as endwalls in gas turbine engine components.

2. Description of Related Art

It can be advantageous in gas turbine engines to have three-dimensionally contoured gaspath walls. For example, the endwalls for turbomachine blades and vanes can have surfaces following non-axisymmetric contours cooperating with the airfoils of the blades or vanes to improve flow characteristics. Two different approaches have been taken with respect to how to contour the non-gaspath surface opposed to the gaspath surface on such components.

The first approach is to have the non-gaspath surface simply follow an offset of the contour of the gaspath surface. This provides a constant wall thickness between the gaspath and non-gaspath surfaces, which prevents structural variation in wall thickness. However, it requires forming a relatively intricate non-axisymmetric surface for the non-gaspath surface where the surface contour does not need to be contoured for flow purposes.

The second approach is to define the non-gaspath surface along an arbitrary axisymmetric contour. This approach provides an easy to manufacture non-gaspath surface, but tends to involve an element of trial and error, or other non-systematic techniques, resulting in portions of the gaspath wall that are too thick or thin. It is possible under this second approach, for example to have a part that is unnecessarily heavy, e.g., for aerospace applications, due to being too thick in places. The same part can also be structurally unsuitable due to a wide variation in wall thickness and can even fail to provide a minimum wall thickness in portions that are too thin.

Such conventional methods and systems have generally been considered satisfactory for their intended purpose. However, there is still a need in the art for improved techniques for contouring non-gaspath surfaces of gaspath walls. The present disclosure provides a solution for these problems.

### SUMMARY OF THE INVENTION

An engine component includes a gaspath wall defining a radially outward facing gaspath surface and an opposed non-gaspath surface. The gaspath surface defines a non-axisymmetric contour with a respective point of minimum radius for each axial position. The non-gaspath surface defines an axisymmetric contour. Each axial position on the axisymmetric contour defines a circle offset from the respective point of minimum radius of the gaspath surface by a predetermined minimum wall thickness. The predetermined minimum wall thickness is a function of axial position.

It is contemplated that the predetermined minimum wall thickness can be substantially constant as a function of axial position. It is also contemplated that an engine component can include a gaspath wall defining a radially inward facing gaspath surface and an opposed non-gaspath surface. The gaspath surface defines a non-axisymmetric contour with a respective point of maximum radius for each axial position. The non-gaspath surface defines an axisymmetric contour wherein each axial position on the axisymmetric contour defines a circle offset from the respective point of maximum radius of the gaspath surface by a predetermined minimum wall thickness.

In certain embodiments, the gaspath wall is an annular segment for forming a portion of an inner or outer wall for an annular flow path with a plurality of similar annular segments. The annular segment can be an endwall with a turbomachine blade or vane extending radially inward or outward therefrom, e.g., the turbomachine blade or vane extends into the gaspath. It is also contemplated that the gaspath wall can define a full annular, i.e., non-segmented, wall. For example, the gaspath wall can be a segmented or non-segmented inner or outer wall, or portion thereof, for a fan, a compressor, a combustor, a turbine, an inlet, a diffuser, a transition duct, a mid-turbine frame, a turbine exhaust case, an exhaust duct, an afterburner duct, a nacelle, a secondary flow system, a nozzle for a gas turbine engine, or any other suitable component.

It is also contemplated that an engine component can include both a gaspath wall with a radially inward facing gaspath surface defining a non-axisymmetric contour and a radially outward facing gaspath surface defining non-axisymmetric contour as described above. The predetermined minimum wall thicknesses of the two gaspath walls can be the same or different from one another.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a perspective view of an exemplary embodiment of an engine component constructed in accordance with the present disclosure, showing endwalls each with a non-axisymmetric gaspath surface contour and opposed axisymmetric non-gaspath surface contour;

FIG. 2 is a schematic perspective view of a prior art gaspath wall, showing a non-gaspath surface with a non-axisymmetric contour that is a direct offset of the non-axisymmetric gaspath surface contour;

FIG. 3 is a schematic perspective view of another prior art gaspath wall, showing a non-gas-path wall with an arbitrary axisymmetric surface contour;

FIG. 4 is a schematic perspective view of a gaspath wall surface with a non-axisymmetric contour, showing maximum and minimum radius points at a single axial station along the surface for use in defining an axisymmetric non-gaspath surface contour;

FIG. 5 is a plot representing the gaspath wall surface of FIG. 4, showing the envelope defined by the maximum radius curve and the minimum radius curve; and

FIG. 6 is a plot representing the axisymmetric non-gaspath surface contour corresponding to the gaspath wall surface of FIG. 5 for an outer diameter wall of an annular gaspath, and also showing an axisymmetric non-gaspath surface contour defined by a similar process to that used in FIGS. 4-5 for an inner diameter wall for the annular gaspath.

### DETAILED DESCRIPTION OF THE PREFERRED EMBODIMENTS

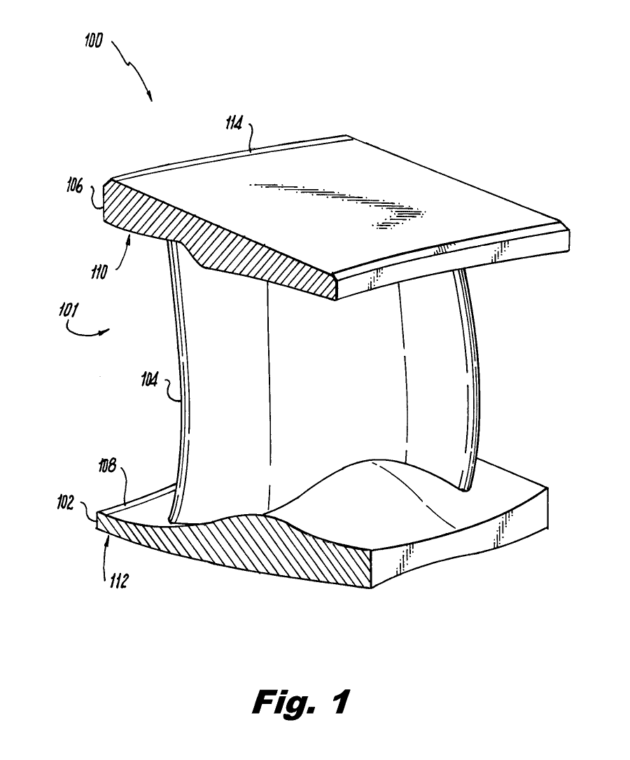

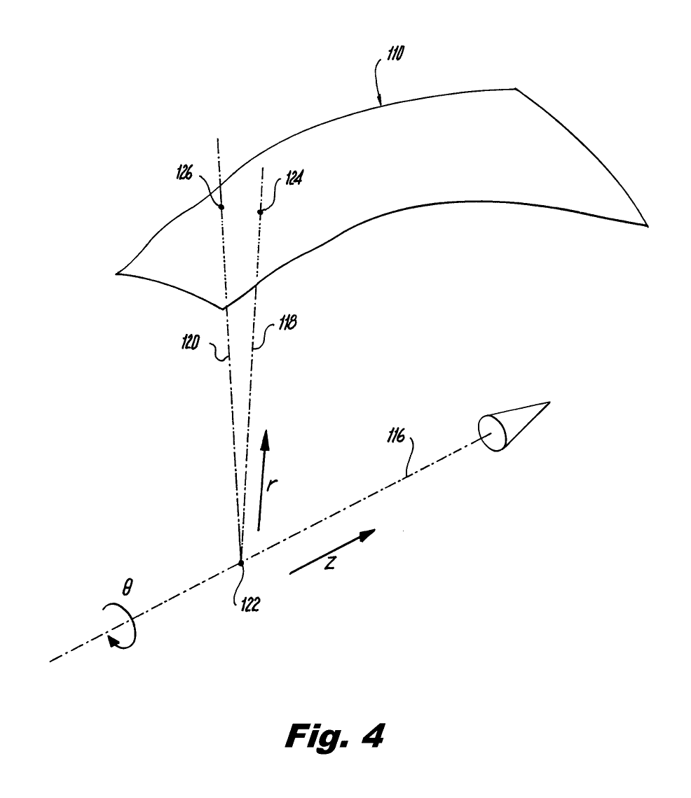

Reference will now be made to the drawings wherein like reference numerals identify similar structural features or aspects of the subject disclosure. For purposes of explanation and illustration, and not limitation, a partial view of an exemplary embodiment of an engine component in accordance with the disclosure is shown in FIG. 1 and is designated generally by reference character 100. Other embodiments of engine components in accordance with the disclosure, or aspects thereof, are provided in FIGS. 4-6, as will be described. The systems and methods described herein can be used to improve design and manufacture of non-gaspath surface contours, such as in gas turbine engine components.

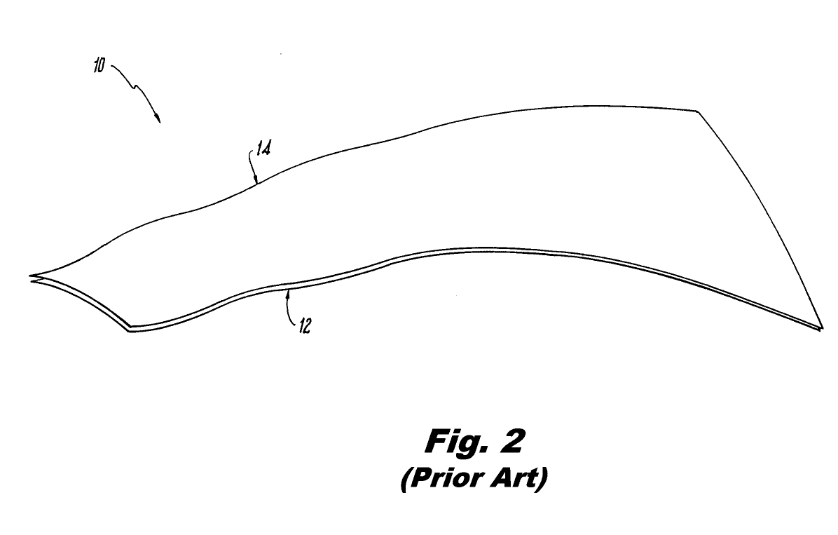

A gaspath endwall may be a surface which is axisymmetric about the engine centerline, e.g., in a gas turbine engine, or can be a three-dimensionally contoured surface which is circumferentially periodic but not axisymmetric about the engine center line. Three-dimensional endwall contouring may be used in the gaspath of a gas turbine engine to improve stage performance. As shown in FIG. 2, the non-gaspath surface 12 of a gaspath endwall 10 incorporating contoured endwall geometry on the gaspath surface 14 may be defined as an offset of the gaspath surface 14. In other words, the wall thickness is uniform in endwall 10, which can be advantageous in terms of weight and structural soundness. However, using a direct offset of a three-dimensionally contoured surface as shown in FIG. 2 has the disadvantage of carrying the topological complexity of the surface through to the non-gaspath side of the platform.

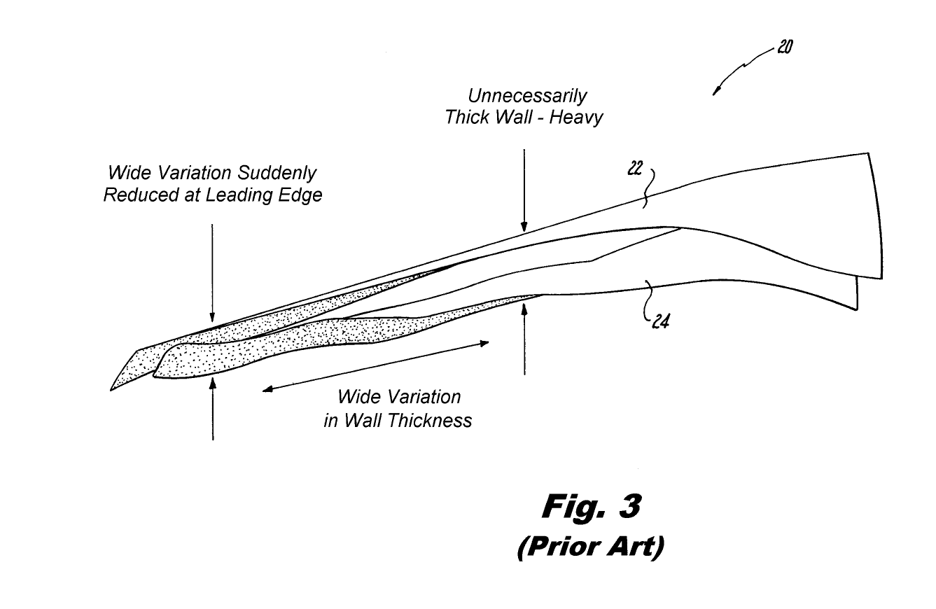

For manufacturing purposes, it is desirable to create a non-gaspath platform surface which is axisymmetric. FIG. 3 schematically shows an example of an endwall 20 with a non-axisymmetric gaspath surface 24 and opposed axisymmetric non-gaspath surface 22. This provides the advantages of ease of manufacture, but introduces structural challenges due to the arbitrary axisymmetric contour of non-gaspath surface 22. As indicated in FIG. 3, there is a wide variation in wall thickness in endwall 20. The unnecessarily thick portions of the wall represent unnecessary weight, whereas the thinness of the endwall 20 in places such as the leading edge may not provide a suitable minimum wall thickness.

Referring again to FIG. 1, this disclosure provides a solution to the problems above, e.g., providing a non-gaspath surface contour that can preserve minimum wall thickness, reduce or minimize thickness variation, and reduce or minimizing unnecessary weight. Engine component 100 of FIG. 1 is a turbine vane with an inner endwall 102 from which extends a turbomachine vane 104, e.g., a turbine vane. Vane 104 also extends radially inward from outer endwall 106. A gaspath 101 is defined between endwalls 102 and 106, i.e. endwalls 102 and 106 are gaspath walls with vane 104 extending through gaspath 101 for control of flow therethrough. A gaspath surface 108 is defined on the radially outward facing surface of endwall 102, and an opposed gaspath surface 110 is defined on the radially inward facing gaspath surface of endwall 106. The gaspath surfaces 108 and 110 are contoured in three-dimensions, wherein the contours are non-axisymmetric.

With continued reference to FIG. 1, endwall 102 has a non-gaspath surface 112 opposed to gaspath surface 108. Similarly, endwall 106 includes a non-gaspath surface 114 opposed to gaspath surface 110. In the case of non-gaspath surface 112, e.g., on an inner diameter endwall 102, the corresponding gaspath surface 108 defines a non-axisymmetric contour with a respective point of minimum radius for each axial position. Non-gaspath surface 112 defines an axisymmetric contour, wherein each axial position on the axisymmetric contour defines a circle offset from the respective point of minimum radius of the gaspath surface 108 by a predetermined minimum wall thickness.

The predetermined minimum wall thickness can be substantially constant as a function of axial position, however it is also contemplated that the predetermined minimum wall thickness can vary as a predetermined function of axial position. For example, it may be desirable in certain applications for the minimum wall thickness in the middle axial position of a component to be thinner than that at the leading and/or trailing edges. As another example, a relatively thin wall may be acceptable at the leading edge of a part, but a relatively thick wall thickness is necessary for structural reasons at the trailing edge. The predetermined function could match the relatively thin offset at the leading edge, as well as matching the relatively thick offset at the trailing edge, and the intermediate portion can be an axisymmetric blend that is tangent to both the leading and trailing edge zones. So the non-gaspath surface is still offset from the minimum radius in each axial location, but the offset value or minimum predetermined wall thickness can vary as a predetermined function of axial position as necessary to allow tailoring for specific applications.

The contour of a non-gaspath surface on inner diameter endwall 102 has been described above. The following describes the contour of a non-gaspath surface on an outer diameter endwall, namely non-gaspath surface 114 of endwall 106. The non-axisymmetric contour of gaspath surface 110 defines a respective point of maximum radius for each axial position. Non-gaspath surface 114 defines an axisymmetric contour wherein each axial position on the axisymmetric contour defines a circle offset from the respective point of maximum radius of gaspath surface 110 by a predetermined minimum wall thickness. The predetermined minimum wall thickness can be substantially constant as a function of axial position, or can vary as a function of axial position as described above.

Referring now to FIG. 4, a technique of determining the contours for axisymmetric non-gaspath surfaces is described. FIG. 4 schematically shows a gaspath surface 110 and the engine centerline 116. The surface contour for non-gaspath surface 114 (shown in FIG. 1) is defined in cylindrical coordinates by circumferentially (in the 0 direction) analyzing the three-dimensional contoured gaspath surface 110 at axial positions or stations along the z direction, and determining the maximum and minimum radius (r) values for each axial station. In FIG. 4, the maximum radius 118 and minimum radius 120 of gaspath surface 110 in the 0 direction are shown for axial station 122. The maximum and minimum radius in the 0 direction can be determined for each axial station in the z direction along engine centerline 116. In FIG. 5, the maximum radius envelope defining point 124 and minimum radius envelope defining point 126 are plotted for each axial station z along the engine centerline 116 for gaspath surface 110. The plot in FIG. 5 shows an envelope 132 surrounded by the maximum radius curve 128 and minimum radius curve 130, defined by the traces of points 124 and 126, respectively, as a function of axial position or axial station along engine centerline 116 in the z direction.

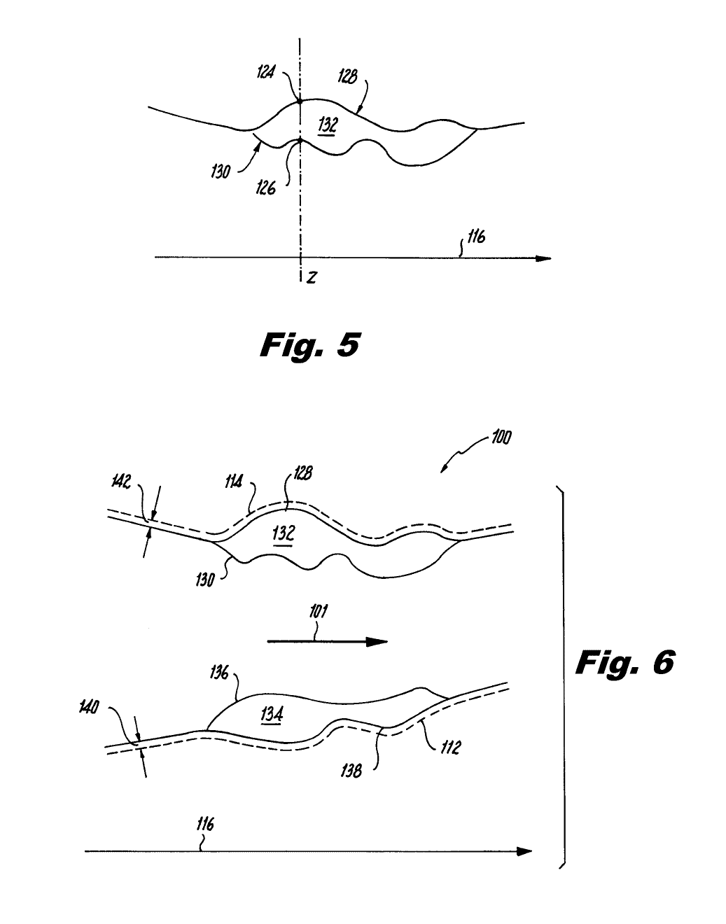

Referring now to FIG. 6, envelope 132 from FIG. 5 is shown with an offset from the maximum radius curve 128 shown in dashed lines. The dashed line represents the axisymmetric contour of non-gaspath wall 114 of FIG. 1. The same process described above for determining envelope 132 can be repeated for the inner diameter endwall 102 to determine envelope 134 using maximum radius curve 136 and minimum radius curve 138. In this case, the axisymmetric contour for non-gaspath surface 112 is an offset of minimum radius curve 138 as indicated in the dashed line in FIG. 6. The offset represents the minimum thickness 140, which minimum is constant along the engine centerline 116. Non-gaspath wall 114 similarly observes a constant minimum thickness 142 along engine centerline 116. The minimum thicknesses 140 and 142 can be identical, or can be different from one another, and/or can be non-constant functions of axial position as needed on an application by application basis.

Those skilled in the art will readily appreciate that it is not necessary to determine the minimum radius curve for an outer diameter endwall or to determine the maximum radius curve for an inner diameter endwall. In short, the outer diameter non-gaspath walls can be defined by offsetting the maximum radius curve for the respective outer diameter gaspath walls, and inner diameter non-gaspath walls can be defined by offsetting the minimum radius curve for the respective inner diameter gaspath walls. Spline smoothing may be employed to attenuate inflections and ripples in the axisymmetric contours in order to simplify them for manufacturing purposes and reduce potential geometric stress risers.

Those skilled in the art will readily appreciate that high pressure turbine vanes are only one example where the contouring described herein can be used, and that any other suitable gaspath components, including those with blades or those having no blades or vanes, can be used without departing from the scope of this disclosure. In FIG. 1, the gaspath walls 102 and 106 are annular segments for forming a portion of an inner and outer wall for an annular flow path, i.e., gaspath 101, with a plurality of similar annular segments. It is also contemplated that the gaspath wall can define a full annular, i.e., non-segmented, wall. For example, the gaspath wall can be an inner or outer wall, or portion thereof, for a fan, a compressor, a combustor, a turbine, an inlet, a diffuser, a transition duct, a mid-turbine frame, a turbine exhaust case, an exhaust duct, an afterburner duct, a nacelle, a secondary flow system, a nozzle for a gas turbine engine, or any other suitable component.

There are various potential benefits for using the non-gaspath contouring techniques described herein. These include axisymmetric non-gaspath walls that are easier to manufacture than in direct offset techniques, minimum thickness (e.g., thicknesses 140 and 142) is maintained relative to the gaspath side of the wall, the endwalls are protected against structural deficiencies caused by undue thinness, wall thickness variation is reduced or minimized, walls are protected against structural deficiencies caused by variation in wall thickness, and part weight is reduced relative to an arbitrary axisymmetric non-gaspath wall.

The methods and systems of the present disclosure, as described above and shown in the drawings, provide for engine components with superior properties including improved non-gaspath surface contours. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. An engine component comprising:
a gaspath wall defining a radially outward facing gaspath surface and an opposed non-gaspath surface, wherein the gaspath surface defines a non-axisymmetric contour with a respective point of minimum radius for each axial position, and wherein the non-gaspath surface defines an axisymmetric contour wherein each axial position on the axisymmetric contour defines a circle offset from the respective point of minimum radius of the gaspath surface by a predetermined minimum wall thickness, wherein the predetermined minimum wall thickness is a function of axial position.

2. An engine component as recited in claim 1, wherein the predetermined minimum wall thickness is substantially constant as a function of axial position.

3. An engine component as recited in claim 1, wherein the gaspath wall includes a plurality of annular segments defining an inner wall for an annular flow path.

4. An engine component as recited in claim 3, wherein the gaspath wall is an endwall wherein each annular segment includes one of a turbomachine blade and a turbomachine vane extending radially outward therefrom.

5. An engine component as recited in claim 1, wherein the gaspath wall is an inner wall for at least one of a fan, a compressor, a combustor, a turbine, an inlet, a diffuser, a transition duct, a mid-turbine frame, a turbine exhaust case, an exhaust duct, an afterburner duct, a nacelle, a secondary flow system, and a nozzle for a gas turbine engine.

6. An engine component as recited in claim 1, wherein the gaspath wall is a portion of an inner wall for at least one of a fan, a compressor, a combustor, a turbine, an inlet, a diffuser, a transition duct, a mid-turbine frame, a turbine exhaust case, an exhaust duct, an afterburner duct, a nacelle, a secondary flow system, and a nozzle for a gas turbine engine.

7. An engine component as recited in claim 1, wherein the gaspath wall is an annular segment for forming a portion of an inner wall for an annular flow path with a plurality of similar annular segments.

8. An engine component as recited in claim 7, wherein the gaspath wall is an annular endwall segment and includes one of a turbomachine vane and a turbomachine blade extending radially outward therefrom.

9. An engine component comprising:
a gaspath wall defining a radially inward facing gaspath surface and an opposed non-gaspath surface, wherein the gaspath surface defines a non-axisymmetric contour with a respective point of maximum radius for each axial position, and wherein the non-gaspath surface defines an axisymmetric contour wherein each axial position on the axisymmetric contour defines a circle offset from the respective point of maximum radius of the gaspath surface by a predetermined minimum wall thickness, wherein the predetermined minimum wall thickness is a function of axial position.

10. An engine component as recited in claim 9, wherein the predetermined minimum wall thickness is substantially constant as a function of axial position.

11. An engine component as recited in claim 9, wherein the gaspath wall includes a plurality of annular segments defining an outer wall for an annular flow path.

12. An engine component as recited in claim 11, wherein the gaspath wall is an endwall wherein each annular segment includes one of a turbomachine vane and a turbomachine blade extending radially inward therefrom.

13. An engine component as recited in claim 9, wherein the gaspath wall is an outer wall for at least one of a fan, a compressor, a combustor, a turbine, an inlet, a diffuser, a transition duct, a mid-turbine frame, a turbine exhaust case, an exhaust duct, an afterburner duct, a nacelle, a secondary flow system, and a nozzle for a gas turbine engine.

14. An engine component as recited in claim 9, wherein the gaspath wall is a portion of an outer wall for at least one of a fan, a compressor, a combustor, a turbine, an inlet, a diffuser, a transition duct, a mid-turbine frame, a turbine exhaust case, an exhaust duct, an afterburner duct, a nacelle, a secondary flow system, and a nozzle for a gas turbine engine.

15. An engine component as recited in claim 9, wherein the gaspath wall is an annular segment for forming a portion of an outer wall for an annular flow path with a plurality of similar annular segments.

16. An engine component as recited in claim 15, wherein the gaspath wall is an annular endwall segment and includes one of a turbomachine vane and a turbomachine blade extending radially inward therefrom.

17. An engine component comprising:
a first gaspath wall defining a radially outward facing first gaspath surface and an opposed first non-gaspath surface, wherein the first gaspath surface defines a first non-axisymmetric contour with a respective point of minimum radius for each axial position, and wherein the first non-gaspath surface defines a first axisymmetric contour wherein each axial position on the first axisymmetric contour defines a circle offset from the respective point of minimum radius of the first gaspath surface by a first predetermined minimum wall thickness, wherein the first predetermined minimum wall thickness is substantially constant as a function of axial position; and
a second gaspath wall radially opposed to the first gaspath wall and defining a radially inward facing second gaspath surface and an opposed second non-gaspath surface, wherein the second gaspath surface defines a second non-axisymmetric contour with a respective point of maximum radius for each axial position, and wherein the second non-gaspath surface defines a second axisymmetric contour wherein each axial position on the second axisymmetric contour defines a circle offset from the respective point of maximum radius of the second gaspath surface by a second predetermined minimum wall thickness, wherein the second predetermined minimum wall thickness is substantially constant as a function of axial position.

18. An engine component as recited in claim 17, wherein at least one of the first and second gaspath walls includes a plurality of annular segments defining a wall for an annular flow path.

19. An engine component as recited in claim 17, wherein the first and second predetermined minimum wall thicknesses are the same.

20. An engine component as recited in claim 17, wherein the first and second predetermined minimum wall thicknesses are different from one another.
